(19) United States
(12) Patent Application Publication
(10) Pub. No.: US 2011/0035048 A1
(43) Pub. Date: Feb. 10, 2011

(54) METERING CONVEYOR

(76) Inventors: Michal Mikulec, Velka Dobra (CZ); Klaus Kohlmueller, Worpswede (DE)

Correspondence Address: JACOBSON HOLMAN PLLC, 400 SEVENTH STREET N.W., SUITE 600, WASHINGTON, DC, 20004, US

(21) Appl. No.: 12/734,748

(22) PCT Filed: Nov. 13, 2008
(86) PCT No.: PCT/EP2008/009612

§ 371 Date: Sep. 20, 2010

(30) Foreign Application Priority Data
Nov. 20, 2007 (DE) 10 2007 055 566.2

(51) Int. Cl. G06F 7/00; B65G 33/14; B65G 25/00

(52) U.S. Cl. 700/230; 198/670; 414/158

(57) ABSTRACT

The task to provide a weigh feeder that permits more reliable control of the amount of bulk material transported by the weigh feeder is solved according to the invention in that a motor-driven conveyor is mounted separately and completely floating to convey the bulk material, in which a number of measurement devices are provided that are arranged and designed in order to determine the weight load of the conveyor from the bulk material. Through separate, completely floating support of the conveyor, a uniform force effect on the support of the conveyor and on the load cells arranged on it is achieved. The conveyor can therefore be weighed without a lever effect caused by a fixed bearing. Through separate, completely floating support of the conveyor, exclusively the weight of the entire conveyor without the weight of other components of the weigh feeder can also be determined.

The present invention concerns a weigh feeder for bulk material. The present invention especially concerns a screw weigh batcher or a screw weigher, which can be used, for example, to supply an incinerator with combustible material. The present invention also concerns a weigh feeder or screw weigh batcher with an intermediate vessel, in which the combustible material fed to the incinerator is held.

A generic weigh feeder is already described in Patent Application DE 10 2007 055 566.2 with a filing date of Nov. 20, 2007, whose disclosure content and priority are fully claimed. The present invention pertains to modifications of the screw weigh batcher for bulk material described in the priority application. A generic weigh feeder includes a weigh batcher with a conveyor, like for example a conveyor screw, through which the bulk material is conveyed from the outlet of a bulk material container to the input of an incinerator. The conveyor is arranged with one end beneath the outlet of a bulk material container, in which the bulk material is kept. The bulk material discharged from the bulk material container is accepted in the receiving end or inlet end of the conveyor, transported by the conveyor to the opposite output end or discharge end of the conveyor and discharged there via a discharge tube.

An incinerator is often connected to the output end of the conveyor, in which the bulk material, like shredded plastic or ground household waste for example, is to be burned. For proper feed of the incinerator, it is important to know which amount of bulk material is fed to the incinerator as fuel or as secondary fuel per unit time, in order to be able to keep possible pollutant emissions of the incinerator within certain limits. It is therefore significant to measure and meter as precisely as possible the amount and weight of the bulk material discharged from the bulk material discharge of the bulk material container before the combustible material is fed to the incinerator.

Known weigh batchers according to the prior art are ordinarily anchored on a fixed support framework and supported by fixed bearings, like cross-spring joints, which is not sufficient for weighing of the weight load with a required accuracy. Fixed support of the bulk material discharge can produce incorrect measurements, because any position change of the support framework, for example, from thermal fluctuations, can distort the measurements, due to fixed mounting. Finally, loading of the conveyor with bulk material from the bulk material conveyor is also subject to fluctuations, because the material kept in the bulk material container can form sidewall angles during incomplete filling of the bulk material container, which can lead to irregular discharge of bulk material from the bulk material container.

In the weigh batcher just mentioned according to the prior art, a self-aligning bearing is provided on the output end or on the bulk material discharge of the conveyor, which is equipped with a load cell. The loads of the self-aligning bearing on the bulk material discharge of the conveyor can be determined via the load cell. In this weigh batcher according to the prior art, the conveyor is mounted floating only on the output end or bulk material discharge of the conveyor via the self-aligning bearing relative to the fixed support framework, whereas a self-aligning bearing that acts as a fixed bearing is provided on the opposite receiving end or inlet end of the conveyor. The weigh batcher according to the prior art undergoes lever effects on this account, which are caused by the self-aligning bearing on the inlet end acting as a fixed bearing.

Because of this self-aligning bearing acting as a fixed bearing on the inlet end, in the weigh batcher according to the prior art inaccuracies still occur in measuring the bulk material transported on the conveyor. Moreover, a lever effect is produced from the floating support on one side of the conveyor and self-aligning bearing acting as a fixed bearing on the opposite side of the conveyor, which hampers determination of the weight load of the conveyor. This lever effect is expressed, for example, by nonuniform weight load as a function of the position of the center of gravity of the bulk material transported on the conveyor, so that measurement of the load cell at the outlet end of the conveyor is adversely affected.

Another drawback of the weigh batcher according to the prior art is that both the weight of the conveyor and the weight of the bulk material container rests on the self-aligning bearing acting as fixed bearing on the receiving end or inlet end of the conveyor. A measurement device or weighing cell arranged on this bearing can therefore only measure the weight of the conveyor together with the weight of the bulk material container, which leads to additional inaccuracies, if only the weight load of the conveyor is to be determined.

One task of the present invention is therefore to provide a weigh feeder for bulk material that overcomes the aforementioned drawbacks. A further task of the present invention is to provide a screw weigh batcher of the type just mentioned, which permits more reliable determination of the weight load of the conveyor and more reliable control of the amount of bulk material transported by the weigh feeder, which is especially independent of the shift in center of gravity of the bulk material transported on the conveyor. These tasks are solved by the present invention through a weigh feeder and a method for operation of a weigh feeder with the features mentioned in the independent claims. Preferred modifications are mentioned in the dependent claims.

The present invention solves the aforementioned tasks through a weigh feeder for bulk material with a motor-driven conveyor to convey the bulk material, in which the conveyor is mounted separately and completely floating, a number of measurement devices being provided, which are arranged and designed in order to determine the weight load of the conveyor from the bulk material.

The expression “separate and completely floating support” in the present context means that the conveyor is mounted separately and freely movable relative to a support structure, like for example a support framework, to all suspension points and support locations, so that only the weight load of the conveyor from the bulk material transported on it relative to the support structure is directly and exclusively transferred into the support structure via the suspension points or support locations. This means that the weight load that the conveyor experiences because of the transported bulk material, is taken up exclusively by the suspension points or support locations of the conveyor relative to the support structure. The sum of all weight loads of the support locations of the conveyor therefore also corresponds to the total weight load that the conveyor experiences from the transported bulk material.

Because of completely floating support of the conveyor, on the one hand, a uniform force effect on the support of the conveyor and on the load cells arranged on it is achieved. The conveyor can therefore be weighed without a lever effect caused by a fixed bearing. Because of separate support of the conveyor, the weight of the entire conveyor without the weight of other components of the weigh feeder can be determined exclusively. In the design of the weigh feeder according to the prior art, only the weight of the weigh feeder with the weight of the bulk material container and the intermediate container can thus far be weighed. On the other hand, the weigh feeder according to the present invention offers the advantage that only the weight of the conveyor is weighed and the weight load determined from it, which the conveyor experiences from the transported bulk material. In this way, more exact determination of the weight of the bulk material conveyed by the weigh feeder is possible.

The present invention uses the described effects of separate and complete floating support by preferably arranging at all suspension points or support locations of the conveyor relative to the support structure a number of measurement devices, for example, load cells or weighing cells, which measure the weight loads that act on the conveyor from the bulk material transported on it. By summing all the individual weight loads measured at the support locations of the conveyor via the weighing cells, the exclusively weight load of the conveyor from the transported bulk material can be continuously and reliably determined. Due to separate and completely floating support of the conveyor relative to the support structure, a uniform force effect on the support of the conveyor and on the load cells or weighing cells arranged on it can also be achieved. The weight load of the conveyor in the weigh feeder according to the invention is no longer determined on one side or on one support, which was the case in the known weigh feeder. Owing to separate and completely floating support of the conveyor, lever effects that interfere with load measurement also can no longer develop.

In the screw weigh batcher mentioned in the introduction according to the prior art, the conveyor screw is weighed, together with the bulk material container or intermediate container. Weighing of the conveyor screw also occurs in the known screw weigh batcher on only one side via a weighing cell on the discharge end of the conveyor screw, so that the force effect on the weighing cell at the discharge of the conveyor screw is dependent on the position of the transporting mass or fuel in the conveyor screw. The closer the center of gravity or mass concentration of the bulk material to the discharge end of the conveyor screw and the single weighing cell arranged there, the greater the weight load on the discharge end of the conveyor screw and the force effect on the weighing cell arranged there. The opposite self-aligning bearing at the input end of the conveyor screw is not used in the known screw weigh batcher for weight determination of the conveyor screw and therefore acts as a fixed bearing. On the other hand, in the screw weigh batcher according to the invention, the total force acting on the weighing cells is independent of the position of the transported mass or bulk material on the conveyor.

According to a preferred variant of the present invention, a number of measurement devices are arranged in the area of the floating support of the conveyor between the conveyor and a support structure, on which the conveyor is mounted separately and completely floating. Floating support of the conveyor relative to the support structure can be achieved, for example, via a number of floating self-aligning bearings. A measurement device that determines the weight load of the corresponding bearing can then be provided on each floating self-aligning bearing. The sum of all individual loads therefore gives the total weight load of the conveyor relative to the support structure. The measurement devices can be load cells or weighing cells, for example, that are suitable for measurement of weight loads. It is significant for the present inventive idea that the conveyor is mounted separately floating and the weight load on each individual bearing of the conveyor is considered in order to determine the total weight of the conveyor.

A preferred variant of the invention proposes that the conveyor is mounted via self-aligning bearings on the support structure or support framework. For this purpose, the conveyor can be supported on its receiving end or inlet end via a first self-aligning bearing mounted floating and on its opposite outlet end or discharge end via at least a second self-aligning bearing mounted floating on the support framework. Such a floating self-aligning bearing is expediently designed, so that it has at least one load cell or weighing cell, whose force-introducing part is coupled with a punch via a first spherical surface, in which the opposite end of the punch is coupled to the support framework via a second spherical surface.

The floating character of support for the conveyor of the weigh feeder according to the invention manifests itself in that the support preferably offers all degrees of freedom. This means that the conveyor can freely move via the floating support relative to a support structure or support framework in all horizontal directions within a certain range. Floating support also offers a certain movement freedom in the vertical direction to the conveyor relative to the support structure. The support of the conveyor in the vertical direction is then acted upon with a spring force, dimensioned so that the conveyor, together with the weight load of the bulk material transported on it, can be supported. Because of this, the conveyor can move on the floating support as a function of its total weight in the vertical direction relative to the support structure.

The spring force, with which floating support is supported in the vertical direction, can be provided by load cells or weighing cells for example, each of which are arranged beneath the bearing. Such load cells or weighing cells are known, for example, from documents DE 11 29 317 A1 or DE 39 24 629 C2 or DE 37 36 154 C2. A load cell or weighing cell converts a force applied to its force-introducing part to an electrical signal, which is processed in an evaluation circuit. In the present invention, the yielding of the support in the vertical direction from the weight of the conveyor can be recorded in these load cells or weighing cells and the weight load of the bulk material transported on it therefore determined.

According to another preferred variant of the present invention, the weigh feeder is designed as a screw weigh batcher or screw weigher to supply an incinerator with combustible material. The conveyor can be designed as a conveyor screw, for example, or also a conveyor belt, in which the motor drive of the conveyor is preferably controllable. The weigh feeder can also be equipped with a speed measurement device that measures the conveyor speed of the conveyor.

The weigh feeder advantageously includes electronic devices, like a microcomputer for example, in order to evaluate the measured signals of the operating parameters determined by the speed measurement device and the weight load measurement devices and to determine from them the load and/or conveyor output of the conveyor. The weigh feeder can also be equipped with electronic devices, in order to determine the weight load of the conveyor from the sum or an average of the measured values of the operating parameters furnished by several measurement devices.

Electronic devices can also be provided that are capable of comparing a load of the conveyor determined by the measurement devices with a stipulated target value of the load. Moreover, electronic devices can be provided that control the speed of the motor drive of the conveyor and/or the discharge output of a metering device, from which the bulk material is released to the conveyor, as a function of the comparison between the determined load of the conveyor with the stipulated target value of the load, so that the load of the conveyor is kept constant.

Electronic devices can also be provided, in order to control the speed of the motor drive of the conveyor and/or output of a metering device, from which the bulk material is released to the conveyor. This control preferably occurs as a function of the comparison between the determined load of the conveyor with the stipulated target value of the load, so that a stipulated target value of the load is reached and maintained. Additional electronic devices can be provided, with which the ratio between the speed of the motor drive of the conveyor and the output of the metering device can be adjusted, from which the bulk material is metered onto the conveyor.

In an expedient embodiment, the weigh feeder according to the invention is equipped with an electronic control, through which the drive motor of the conveyor and a number of measurement devices are electrically connected to a first control circuit, so that a control signal for the drive motor is obtained from a comparison of a stipulated target value with a product of the current conveyor load with bulk material and the current speed of its drive motor.

For monitoring of continuous measurement of the feed amount, it can be expedient, if the measured feed amount is compared in a control counter with the actual weight reduction of the bulk material container and the control balanced accordingly during deviations. For this purpose, a control counter that compares the weight reduction of the bulk material container with the measured feed amount of discharge bulk material and indicates deviations can preferably be used.

According to another aspect of the present invention, the aforementioned tasks are solved by a method for operation of a weigh feeder for bulk material, comprising the following steps:
Measurement of the weight load with the conveyor via a number of measurement devices;
Determination of the load of the conveyor from the speed of the motor drive and the weight load of the conveyor;
Comparison of the determined load of the conveyor with a stipulated target value of the load; and
Adjustment of the speed of the motor drive of the conveyor and/or adjustment of metering of bulk material onto the conveyor as a function of the comparison between the determined load of the conveyor with the stipulated target value of the load.

With this method for operation of the weigh feeder according to the invention for bulk material, the aforementioned advantages can be achieved. The method according to the invention can also include the step:
Determination of the weight load of the conveyor from the sum or an average value of the measured values furnished by several measurement devices.

In this way, it can be ensured that the exact total load of the conveyor is determined from the total of measured values furnished by several measurement devices, like for example load cells or weighing cells, which is obtained through the weight of the bulk material transported by the conveyor. For this purpose, the previously determined or known weight of the conveyor resting on the support structure can be subtracted from the total weight, in order to obtain exclusively the weight of the bulk material transported by the conveyor. In particular, small loads of the conveyor can be determined with high accuracy on this account.

The method according to the invention can also include the step:
Control of the output of a metering device, from which the bulk material is released to the conveyor, as a function of the comparison between the determined load of the conveyor with the stipulated target value of the load.

The exact determination of the weight of the bulk material transported by the conveyor can be utilized, in order to adjust or maintain a stipulated target value of the load of the weigh feeder. For this purpose, control of the speed of the motor drive of the conveyor and/or the output of the metering device can occur, so that a stipulated target value of the load of the weigh feeder is reached. In addition or as an alternative, control of the speed of the motor drive of the conveyor and/or output of the metering device can occur, so that the load of the weigh feeder is kept constant.

The present invention is further explained below by means of preferred practical examples with reference to the appended drawings. In the drawings:

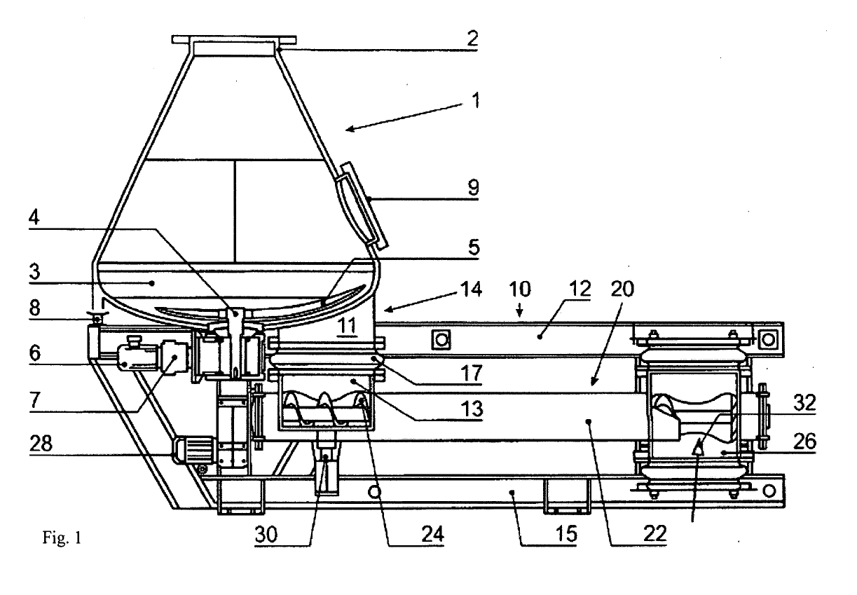

FIG. 1 shows a schematic view of a weigh feeder system according to the prior art,

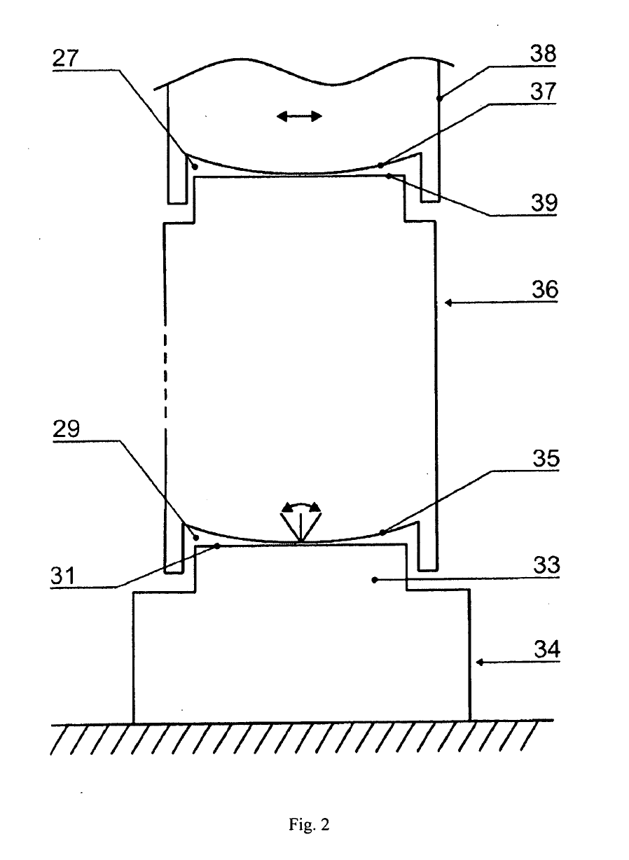

FIG. 2 shows a schematic sketch of the design of a floating self-aligning bearing, as can be used, for example, in the weigh feeding system depicted in FIG. 1,

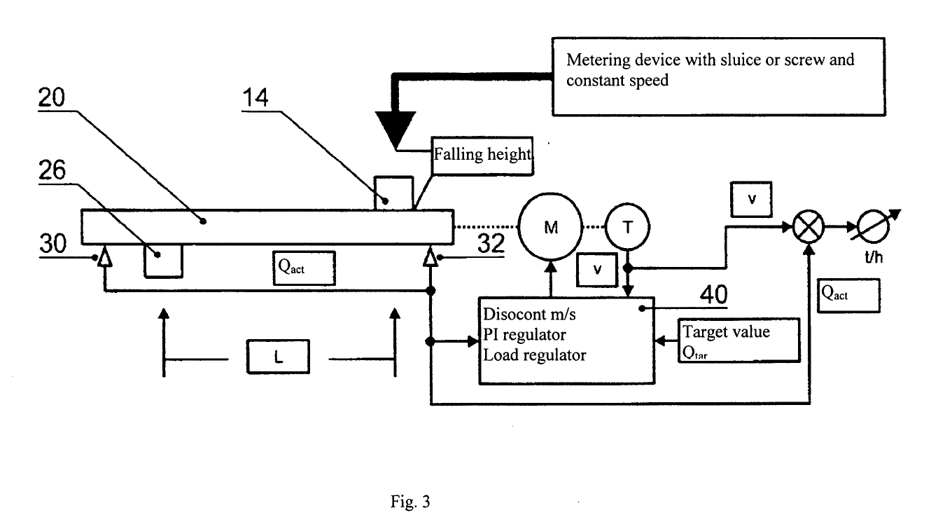

FIG. 3 shows a schematic view of the weigh feeder according to a variant of the present invention with an electronic control circuit, and

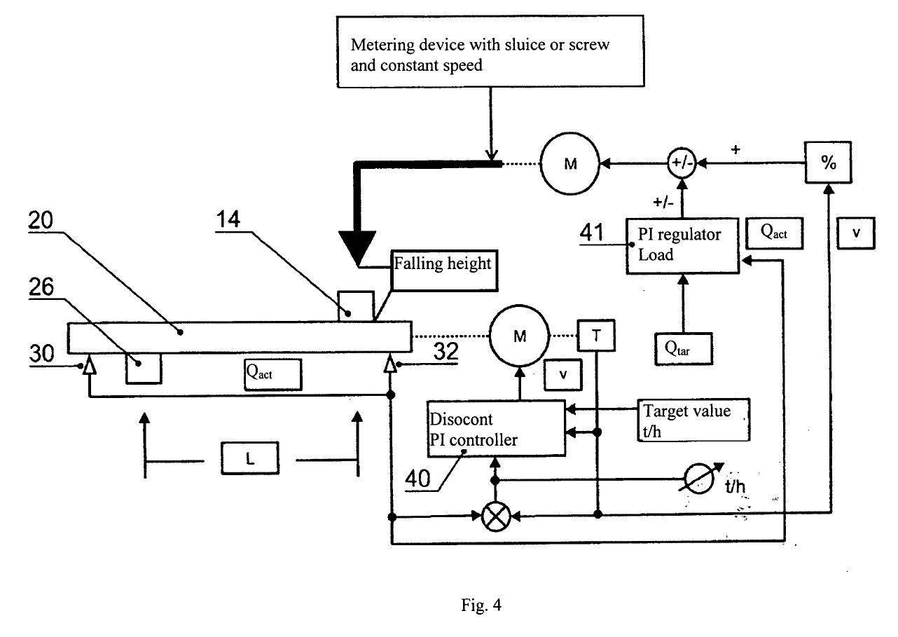

FIG. 4 shows a schematic view of the weigh feeder according to another variant of the present invention with two electronic control circuits.

A schematic view of a known weigh feeder according to the prior art is shown in FIG. 1. In this variant, a pear-shaped bulk material container 1 is fastened on an upper beam 12 of the trapezoidal support structure or support framework 10 made of steel supports, the container having a downward widening truncated cone shape with an upper filling opening 2 for bulk material and a lower circular trough-like bottom 3. An inspection cover 9 is used for visual inspection of the bulk material container interior. The bulk material container 1 is supported via one or more fixed bearings 8 relative to the support structure or support framework 10.

A shaft 4 is arranged centrally on the bottom 3 of the bulk material container 1, to which an agitator blade 5 is splined within the bottom 3. A drive motor 6 is fastened on the bulk material container 1 beneath the bulk material container 1, the output shaft of which is coupled to the shaft 4 via a gear mechanism 7. When the shaft 4 rotates, the agitator blade 5 rotates right above the bottom 3 through the bulk material introduced into the bulk material container 1, loosens and distributes it uniformly over the bottom 3 and fills a cylindrical filling tube 14. The cylindrical filling tube 14 of the metering device is fastened laterally on the bottom 3 of the bulk material container 1 with vertical alignment and its upper end opens into the interior of the bulk material container 1 through an outlet not shown in detail.

The cylindrical filling tube 14 has an upper tube connector 11 and a lower tube connector 13, which are coaxially connected to each other via a flexible sleeve 17. The upper tube connector 11 is fastened on the bottom 3 and the lower tube connector 13 is fastened to a screw weigher 20. The bulk material container 1 and the filling tube 14 can therefore be viewed together as a metering device that releases the bulk material held in the bulk material container 1 to a screw weigher 20, which is arranged beneath the metering device 1, 14. The screw weigher 20 is largely separated by the flexible sleeve 17 from the metering device 1, 14 with the bulk material container 1 and the filling tube 14, so that the screw weigher 20 can execute movements separate from the metering device 1, 14.

The screw weigher 20 includes an elongated protective tube 22, in whose interior a conveyor designed as a conveyor screw 24 is mounted to rotate. A drive motor 28 for the conveyor screw 24 is arranged in space-saving fashion beneath the gear mechanism 7. On the front receiving end or inlet end of the protective tube 22, the lower tube connector 13 of the filling tube 14 is fastened, which extends through a corresponding opening into the interior of the protective tube 22. On its outlet end or discharge end, the protective tube 22 has a lower opening that discharges into a discharge tube 26.

The protective tube 22 of the conveyor screw 24 rests on the beam 12 of the support frame 10 via a number of self-aligning bearings, two of which are indicated in FIG. 1 with reference numbers 30 and 32. The protective tube 22 of the conveyor screw 24 then rests on its receiving end or inlet end roughly in the center relative to the opening of the protective tube 13 over a first self-aligning bearing 30 on a lower beam 15 of the support framework 10. On its opposite output end or discharge end, the protective tube 22 rests via a second self-aligning bearing 32, also on the lower beam 15 of the support framework 10.

As is apparent in FIG. 1, the pear-shaped bulk material container 1 is connected via the filling tube 14 to the upper tube connector 11 and the lower tube connector 13 to the conveyor designed as a conveyor screw 24. Because of this, the bulk material container 1 is also supported on the support framework 10 via the first self-aligning bearing 30. This means that a measurement device arranged on the first self-aligning bearing 30 can determine only the sum of the weight of the bulk material container 1 together with the weight of the conveyor screw 24. The exact determination of the weight of the conveyor screw 24 is impossible on this account.

The present invention solves this problem in that the bulk material container 1 is mounted separately from the screw weigher 20 and the screw weigher 20 or the conveyor 24 is supported separately and completely floating on the support framework 10. In the weigh feeder according to the invention, the screw weigher 20 or conveyor 24 can be supported, for example, via the first self-aligning bearing 30 on the support framework 10, without the bulk material container 1 also being supported. Because of this, a measurement device arranged on the first self-aligning bearing 30 can determine only the weight of the screw weigher 20 or the conveyor 24 without the adverse effect of an additional component of the weigh feeder. The exact determination of the weight of the conveyor 24 and its weight load from the transported bulk material is possible on this account.

The weigh feeder according to the present invention consequently differs from the weigh feeder according to the prior art essentially by complete floating support of the conveyor 24, in which the conveyor 24 is supported separately and therefore independently of other components of the weigh feeder. The other structure of the weigh feeder according to the invention can have consistencies with the design of the weigh feeder according to the prior art shown in FIG. 1. Consequently, practical variants of the weigh feeder according to the invention are also described below with reference to the reference numerals of FIG. 1.

According to one variant of the weigh feeder according to the invention, support of the screw weigher 20 or conveyor 24 can consist of two or more self-aligning bearings 30, 32 mounted to float, one self-aligning bearing 32 of which is arranged on one side of the discharge tube 26 and the other self-aligning bearing 30 on the opposite side of the discharge tube 26. In this way, the conveyor or feed screw 24 can be mounted completely floating and separate relative to the support structure 10. Measurement devices, like load cells or weighing cells (not shown) for example, are arranged on the floating self-aligning bearings 30, 32, which measure the weight load acting on the corresponding self-aligning bearing. Because of this, the entire weight load of the screw weigher 20 according to the invention on the self-aligning bearings 30, 32 mounted floating in the manner described above and the load cells or weighing cells arranged on them can be reliably determined.

In the weigh feeder according to the invention, at least one floating self-aligning bearing can be arranged on one side of an inlet end of the conveyor screw 24 between the conveyor screw 24 and the support structure 10 and at least one additional floating self-aligning bearing can be arranged on the other side on the outlet end of the conveyor screw 24 between the feed screw 22 an the support structure 10. Measurement devices, like weighing cells or load cells for example, are arranged on the bearings 30, 32, which determine the weight load on the corresponding bearing of the screw weigher 20 or the conveyor 24.

The bearings 30, 32 with the measurement devices are advantageously arranged outside the discharge area, in which the bulk material falls onto the conveyor 24 or outside of the receiving area, in which the bulk material is received by the conveyor. It is also advantageous, if the floating bearings with the measurement devices are arranged outside the discharge area, in which the bulk material is released from the conveyor 24. Because of this, the signals recorded by the measurement devices are less disturbed by falling down of the bulk material, and therefore more exact. Because of the possible greater distance to the discharge areas, much simpler additional protective devices (not shown) for the bearings with the measurement devices can also be provided in practice, for example, heat protection during work with hot bulk material.

In the weigh feeder according to the invention, there are no longer fixed bearings between the feed screw 24 and the support structure 10. There is also no longer a connection between the bulk material container 1 and the screw weigher 20 in the weigh feeder according to the invention, so that the weight load of the screw weigher 20 from the bulk material transported in the feed screw 24 can be determined independently of the weight of the intermediate container or bulk material container 1 and/or the metering device 14 at any time and with high accuracy.

A variant of a floating self-aligning bearing 30, 32 is schematically depicted in FIG. 2, as can be used, for example, in a variant of the weigh feeder according to the invention. Each of the self-aligning bearings 30, 32 mounted to float in FIG. 1 can consist of a load cell 34 and a punch 36. A flat surface 31 of the force-introducing part 33 of the load cell 34 is in contact with a convex end surface 35 of the punch 36. A convex surface 37 of a component 38 that moves across the axis of the cylindrical punch 36, for example, the support structure 10 in FIG. 1, is in contact with a flat end surface 39 of the punch 36, in which the end surfaces 35 and 39 are opposite each other.

Through this design, the vertical force transfer from component 38 to load cell 34 remains largely unchanged, even if the moving component 38 moves back and forth by a few millimeters across the longitudinal axis of the load cell 34. Despite these possible movements, the punch 36 remains held, both in the recess 27 provided on the component 38 around the surface 37 and around the raised force-introducing part 33 of the load cell 34, because of a recess 29 of the punch 36 formed on the lower end surface 35. The convex surfaces can also be provided only on the opposite end surfaces of the punch 36, in which case the opposite surfaces 31 and 37 can then be configured flat. The design of these self-aligning bearings makes it possible for the floating conveyor or screw weigher of the weigh feeder according to the invention to be freely movable in the horizontal direction within a certain range, whereas the weight force of the conveyor is sent via the self-aligning bearing in the vertical direction undistorted to the load cells or weighing cells arranged underneath.

As mentioned in the introduction, the present invention can also be used to supply an incinerator with combustible material. For this purpose, the combustible material can be removed via so-called direct discharge from a metering device and fed to the incinerator via the conveyor screw. By means of the weigh feeder according to the invention, the load of the conveyor screw can then be kept constant from the product of the load Q of the conveyor screw with combustible material and the conveyor speed V of the conveyor screw, which can be represented by the equation P=Q·V.

The effective force trend of the aforementioned weigh feeder according to the prior art is not suitable for such a load regulation, in which the load Q of the weigh batcher with bulk material is to be kept constant, and specifically neither as a screw weigh batcher with separate metering control nor as a measuring system with a control. This is mostly caused by the supports acting as fixed bearings of the weigh batcher relative to the support structure and the lever effect resulting from this.

On the other hand, the present invention has the advantage that all bearings of the conveyor are designed as floating bearings, each of which is equipped with a measurement device, all of the weight signals recorded by which are used to determine the total weight of the conveyor. Because of this, weight loads from the weight of the fuel transported on the conveyor screw on the individual self-aligning bearings, both on the one end of the conveyor screw and on the other end and both at the inlet and discharge, are determined with high accuracy by means of weighing cells. This has the advantageous effect that the total load of the conveyor screw can continuously be determined and is not dependent on the position of the transported mass on the conveyor screw.

A schematic view of a practical variant of the weigh feeder according to the invention, given as an example with a control circuit, is shown in FIG. 3. Continuous determination of the weight load of the conveyor screw is made possible according to the invention in that the entire feed screw is supported separately suspended or floating at all support points, for example, via the self-aligning bearings on the inlet end and discharge end of the conveyor screw, and the weight load of the conveyor screw can therefore be determined at all support points via separate weighing cells on the self-aligning bearings. Consequently, the force trend on the weighing cells is independent of the position of the transported mass on the conveyor.

The known screw weigh batcher according to the prior art, on the other hand, is not suitable for variable load control, as is the case in the screw weigh batcher according to the present invention. The known screw weigh batcher cannot be used either as a batcher with separate metering control nor as a measuring system with control of a constant or variable load. On the other hand, the screw weigh batcher according to the present invention offers a larger variety of possibilities for measurement, control and regulation of the load.

A significant advantage of the present invention is consequently due to the constant force introduction into the measurement devices arranged on the support points of the weigh batcher or conveyor screw and consideration of all weight loads at all support points. A control structure can then be made possible, so that the load of the conveyor screw can be measured, adjusted and changed more exactly or kept constant. There is no critical zone in the conveyor screw in the screw weigh batcher according to the invention, within which no measurement of the total load can be made.

For particularly exact determination of the weight load of the metering screw and calculation of the weighing characteristics, the mass falling from a metering device onto the metering screw must also be considered, since a momentum is produced from this that acts on the total load of the metering screw. It can then be assumed as a first approximation that this momentum of the mass falling from the metering device onto the conveyor screw always remains largely constant and can therefore remain unconsidered for determination of the load of the screw weigh batcher.

The falling height of the bulk material onto the weigh batcher can also be kept constant by controlled load regulation. With such a control structure, the conveyor output of the screw weigh batcher at the discharge of the conveyor screw also corresponds to the conveyor output of the metering device. If the conveyor output of the metering device should fluctuate, the conveyor output of the screw weigher also fluctuates to the same degree. High accuracy of conveyor output of the screw weigh batcher can be achieved with the control structure according to the invention, since the load of the screw weigher can be adjusted independently of the conveyor output. In particular, the load of the screw weigher can be kept constant independently of the conveyor output of the screw weigh batcher.

According to another aspect of the present invention, determination of the total load of the screw weigh batcher is combined with a control structure, so that the load of the conveyor screw with combustible material can be kept constant. The design of such a control structure is shown in FIG. 3, in which the weigh feeder according to the invention is only shown schematically. The reference numerals used in FIG. 3 have the following meaning:
P=Nominal conveyor output [kg/h]
t/h=Reading of nominal conveyor power P
Q=Screw load
Q_{act}=Actual screw load of the conveyor screw
Qₜₐᵣ=Target screw load of the conveyor screw
L=Bridge length
M=Screw motor
T=Tachogenerator
V=Screw speed [m/s]
[symbol] =Multiplier

FIG. 3 shows a schematic view of the weigh feeder according to one variant of the present invention with an electronic control circuit, in which the column with gray background represents the screw weigher 20, which is mounted on two floating self-aligning bearings 30 and 32 completely floating and separate, i.e., independently of other components of the weigh feeder system. On the top of the screw weigher 20, the filling tube 14 is shown on its receiving end or inlet end, from which the bulk material reaches the screw weigher 20, and a discharge tube 26 is shown on the output end or discharge end of the screw weigher 20, from which the bulk material is discharged again from the screw weigher 20. Bulk material can be applied to the screw weigher 20 through a filling tube 14 via a conveyor screw or a metering device (not shown). The filling tube 14 and the discharge tube 26 are both arranged between the self-aligning bearings 30, 32.

On the screw weigher 20, the bulk material is transported by a conveyor, for example, a conveyor screw, from the inlet end to the discharge end, where it is released from the screw weigher 20 through a discharge tube 26. The length between the filling tube 14 and the discharge tube 26 of the screw weigher 20, within which the bulk material is transported from the inlet end to the discharge end, is designated with the reference letter L in FIGS. 3 and 4. Since the conveyor screw or screw weigher 20 in the depicted practical examples is mounted only on its inlet end and on its discharge end via self-aligning bearings with weighing cells, the “effective bridge length” is L.

In the variant of the present invention depicted in FIG. 3, the weigh feeder is equipped with an electronic control circuit, with which the screw load of the conveyor screw Q can be kept constant. The screw weigher 20 according to the invention is then used as a measurement system with the adjustment stipulation that the load Q of the screw weigher 20 is kept constant, i.e., Q=constant. Consequently, the load Q of the conveyor screw can be calculated from Q=P·L/V·3.6 [kg].

With the variant of the present invention depicted in FIG. 3, a constant screw load can be achieved independently of the corresponding conveyor strength of a metering device. The control circuit therefore includes electronic devices that are, for example, capable of calculating the ratio Q/L from the load Q of the conveyor screw and the bridge length L, from which the average weight load of the conveyor screw is obtained in [kg/m]. Additional electronic devices of the weigh feeder according to the invention can calculate, for example, a nominal conveyor power P, which is obtained from the product of the load Q and the speed V of the conveyor screw, divided by the effect of the bridge length L: P=Q·V·3.6/L [t/h].

Since the effective force on the weighing cells within the bearing or bridge length is the same at all points, neither lever forces nor critical zones occur in the weigh feeder according to the invention, in which weight measurement would be impossible; instead, measurement of the weight load of the weigh feeder can occur at any time with high accuracy. The weigh feeder according to the invention can include one or more displays, on which the measured or calculated operating parameters of the weigh feeder are shown.

Measurement devices that determine the weight load of the floating weigh feeder 20 and send the measured values to an electronic evaluation unit 40 are arranged on the floating self-aligning bearings 30 and 32 of the weigh feeder 20. The conveyor, like for example a conveyor screw of the weigh feeder 20, is driven by a screw motor M, whose rotation speed is determined by a tachogenerator T. The tachogenerator T also sends measurement signals to the electronic evaluation unit 40, from which the rotational speed of the screw motor M and therefore the conveyor speed V of the conveyor screw follow.

As described above, measurement devices (not shown) are arranged on the weigh feeder 20, which determine the actual load Q_{act} of the conveyor or the conveyor screw. The actual load Q_{act} is multiplied through a multiplier \textcircled{x} by the speed V of the conveyor screw and the nominal conveyor power P of the conveyor or conveyor screw thus determined. The determined nominal conveyor power P of the conveyor screw can be given via a display t/h.

By means of a load regulator 40 (PI regulator), the screw load is regulated with reference to a stipulated or set target screw load Qₜₐᵣ. For this purpose, the screw speed V is recorded by means of a corresponding measurement device on the screw motor M. The screw speed V can be determined by means of a tachogenerator T on the screw motor M. Calculation of the load target value Qₜₐᵣ of the conveyor measurement screw can occur according to the equation Qₜₐᵣ=(P·L)/(V·3.6) [kg], in which the parameters P and V refer to nominal data.

A schematic view of the weigh feeding system according to another variant of the present invention is shown in FIG. 4. The design of the variant shown in FIG. 4 corresponds partly to the variant of the weigh feeder depicted in FIG. 3, so that the description for FIG. 3 is referred to for the agreeing parts of the variants. The reference numerals used in FIG. 4 have the following meaning:
P=Nominal conveyor power [kg/h]
t/h=Display of nominal conveyor power
Q=Screw load, for example, Q=P·L/V·3.6 [kg] (Q/L)=[kg/m]
Qₜₐᵣ=Target screw load of the conveyor screw
Q_{act}=Actual screw load of the conveyor screw
L=Bridge length
M=Screw motor
T=Tachogenerator
V=Screw speed [m/s]
[symbol] =Multiplier
%=Ratio adjuster

In the variant depicted in FIG. 4, the weigh feeder according to the invention is used as a metering system that includes two electronic control circuits. The two control circuits are only schematically depicted in FIG. 4, one control circuit of which regulates the conveyor power P of the screw weigher 20, in order to keep it constant, while the other control circuit is used to control the load of the weigh feeder 20 with the target screw load Qₜₐᵣ and controls it via the metering device. In the first control circuit, the conveyor power P of the conveyor is consequently regulated and with the second control circuit, the screw load Q is regulated with reference to a stipulated or set value of the target screw load Qₜₐᵣ.

The control circuits include a number of electronic components, like for example a first load regulator 40 and a second load regulator 41 (PI regulators). The first load regulator 40 regulates the speed V of a conveyor screw 24 with consideration of a target value for the nominal conveyor power t/h. The second load regulator 41 ensures precise regulation and maintenance of the load Q of the conveyor 24 with consideration of the actual screw load Q_{act} of the conveyor screw. Calculation of the load target value Qₜₐᵣ can occur according to the equation Qₜₐᵣ=(P·L)/(V·3.6) [kg], in which the parameters P and V refer to nominal data.

The speed V of the conveyor screw 24 can also serve as a speed guide value of the metering device. A base setting for the ratio between the screw speed V and the speed guide value of the metering device can then occur via the ratio adjuster %.

An essential aspect of the present invention in comparison with the prior art therefore lies in separate and completely floating support of the weigh feeder 20 with the conveyor or conveyor screw 24 and the uniform trend of the force effect on the floating self-aligning bearings 30, 32 of the weigh feeder 20 caused by this, as well as the load cells or weighing cells arranged on them, based on the weight load of the mass of bulk material transported in the conveyor screw 24. Another essential aspect of the present invention consists of the fact that by separate, completely floating support of the conveyor screw 24, the entire weigh feeder 20 can always be weighed without a lever effect or other interfering effects caused by a fixed bearing.

1. Weigh feeder for bulk material with a motor-driven conveyor (24) to convey bulk material, characterized by the fact that the conveyor (24) is mounted separately and completely floating, a number of measurement devices being provided, arranged and designed to determine the weight load of the conveyor (24) from the bulk material.

2. Weigh feeder according to claim 1, in which a number of measurement devices are arranged in the area of the floating support (30, 32) of the conveyor (24) between the conveyor (24) and a support structure (10), on which the conveyor (24) is mounted completely floating and independent of other components of the weigh feeder.

3. Weigh feeder according to the preceding claim, in which the conveyor (24) is mounted relative to the support structure (10) via a number of floating self-aligning bearings (30, 32).

4. Weigh feeder according to the preceding claim, in which a measurement device is provided on at least one floating self-aligning bearing (30, 32), which determines the weight load of the corresponding bearing (30, 32).

5. Weigh feeder according to the preceding claim, in which the floating self-aligning bearings (30, 32) with the measurement devices are arranged outside the receiving area, in which the bulk material is received by the conveyor (24) and are arranged outside the discharge area, in which the bulk material is discharged from the conveyor (24).

6. Weigh feeder according to one of the preceding claims, in which the conveyor (24) is designed as a conveyor screw or conveyor belt and the motor drive (M) of the conveyor (24) is controllable.

7. Weigh feeder according to one of the preceding claims, in which at least a number of measurement devices are designed as load cells suitable for measurement of weight loads.

8. Weigh feeder according to one of the preceding claims, in which the weigh feeder is designed as a screw weigh feeder or screw weigher (20) to supply an incinerator with combustible material.

9. Weigh feeder according to one of the preceding claims, in which a speed measurement device (M, T) is provided, which measures the conveyor speed (V) of the conveyor (24).

10. Weigh feeder according to one of the preceding claims, in which electronic devices (40, 41) are provided, designed to evaluate the measurement signals determined by the speed measurement device (M, T) and the weight load measurement devices and to determine the load (Q) and/or conveyor power (P) of the conveyor (24) from them.

11. Weigh feeder according to one of the preceding claims, in which electronic devices (40, 41) are provided, designed to determine the weight load of the conveyor (24) from the sum and/or an average value of the measured values furnished by several measurement devices.

12. Weigh feeder according to one of the preceding claims, in which electronic devices (40, 41) are provided, designed to compare a load (Q_{act}) of the conveyor (24) determined by the measurement devices with a stipulated target value (Qₜₐᵣ) of the load.

13. Weigh feeder according to one of the preceding claims, in which electronic devices (40, 41) are provided, designed to control the speed (V) of the motor drive (M) of the conveyor (24) and/or the output of a metering device (1, 14), from which the bulk material is fed to the conveyor (24) as a function of the recorded operating parameters, so that the load (Q) of the conveyor (24) is kept constant.

14. Weigh feeder according to one of the preceding claims, in which electronic devices (40, 41) are provided, designed to control the speed (V) of the motor drive (M) of the conveyor (24) and/or the output of a metering device (1, 14), from which the bulk material is fed to the conveyor (24), as a function of the comparison between the determined load (Q_{act}) of the conveyor (24) with the stipulated target value (Qₜₐᵣ) of the load, so that the load (Q) of the conveyor (24) is kept constant.

15. Weigh feeder according to one of the preceding claims, in which electronic devices (40, 41) are provided, designed to control the speed (V) of the motor drive (M) of the conveyor (24) and/or the output of a metering device (1, 14), from which the bulk material is fed to the conveyor (24) as a function of the comparison between the determined load (Q_{act}) of the conveyor (24) with the stipulated target value (Qₜₐᵣ) of the load, so that the stipulated target value (Qₜₐᵣ) of the load is reached.

16. Weigh feeder according to one of the two preceding claims, in which electronic devices (40, 41) are provided, designed to set the ratio between the speed (V) of the motor drive (M) of the conveyor (24) and the output of the metering device (1, 14).

17. Method for operating a weigh feeder for bulk material according to one of the preceding claims, comprising the following steps:
Measurement of the weight load of the conveyor (24) via a number of measurement devices;
Determination of the load of the conveyor (24) from the speed (V) of the motor drive (M) and the weight load of the conveyor (24);
Comparison of the determined load (Q) of the conveyor (24) with a stipulated target value (Qₜₐᵣ) of the load; and
Adjustment of the speed of the motor drive (M) of the conveyor (24) and/or adjustment of the metering of bulk material to the conveyor (24) as a function of comparison between the determined load (Q_{act}) of the conveyor (24) with the stipulated target value (Qₜₐᵣ) of a load.

18. Method according to claim 15, further comprising the step:
Control of the output of a metering device (1, 14), from which the bulk material is fed to the conveyor (24), as a function of the comparison between the determined load (Q_{act}) of the conveyor (24) with the stipulated target value (Qₜₐᵣ) of the load.

19. Method according to one of the claims 15 to 16, in which control of the speed (V) of the motor drive (M) of the conveyor (24) and/or the output of the metering device (1, 14) occurs, so that the load (Q) of the weigh feeder is kept constant.

20. Method according to one of the claims 15 to 17, in which control of the speed (V) of the motor drive (M) of the conveyor (24) and/or the output of the metering device (1, 14) occurs, so that a stipulated target value (Qₜₐᵣ) of the load of the weigh feeder is reached.

21. Method according to one of the claims 15 to 18, further comprising the step:
Determination of the weight load of the conveyor (24) from the sum and/or from an average value of the measured values furnished by several measurement devices.
